(19) United States
(12) Patent Application Publication
(10) Pub. No.: US 2019/0244514 A1
(43) Pub. Date: Aug. 8, 2019

(54) Long distance wireless control for emergency vehicles equipment

(71) Applicant: Yuhui Wan, West Lafayette, IN (US)

(72) Inventor: Yuhui Wan, West Lafayette, IN (US)

(21) Appl. No.: 16/268,102

(22) Filed: Feb. 5, 2019

Related U.S. Application Data
(60) Provisional application No. 62/627,818, filed on Feb. 8, 2018.

(51) Int. Cl. G08C 17/00; H04W 4/80; H04M 1/725; H04B 7/14; H04W 4/40

(52) U.S. Cl. CPC G08C 17/00; H04W 4/80; B60Q 1/46; H04B 7/14; H04W 4/40; H04M 1/72533

(57) ABSTRACT

A device and method to remotely control via wireless the light bars, sirens, and other equipment in an emergency vehicle.

### CROSS REFERENCE

This application claims the priority of U.S. provisional patent application, Ser. No. 62/627,818 filed on Feb. 8, 2018, and incorporates the subject matter thereof in its entirety.

### FIELD

The present invention relates generally to the field of wireless remote control of light bars, sirens or other emergency vehicle equipment.

### BACKGROUND

Lightbars, sirens and other warning equipment as used on various emergency vehicles have multiple functions. Such light bars and sirens are controlled from control panels or other control devices within the passenger compartments of the emergency vehicles. The control devices are usually physically connected to the light bar or siren by wiring. Frequently, the operators of these vehicles are not in their vehicles but outside their vehicles when a change to a function of a light bar or siren is desired. This necessarily requires the operators to enter the passenger compartment of their vehicles in order to effect a functional change in a light bar or siren. In certain scenarios, there is a desire for operators to be able to control at least some aspects of their light bars and/or sirens remotely.

Some existing systems use a remote control which is specifically designed to use to control light bars, sirens or other emergency vehicle equipment.

Some current remote solutions require operators to carry remote control devices specifically made for control lightbars and siren. The additional remote control devices add weight to the operators' gear. Some other current methods using Wi-Fi function on operators' smart phones limited the internet access of operators' smart phones. All these current methods only have very limited control distance.

There are many examples of the systems that are available in the prior art. For example, U.S. Pat. Nos. 7,825,790, 6,981,363, U.S. Patent Applications 20100194556 and U.S. Patent Applications 20090256697 to Pederson illustrate a light bar including a control system that can receive signals from a wireless remote control, but this system uses specifically designed wireless remote control that does not use communication radio with dual tone multi frequency (DTMF) signal and does not have a system of repeaters. DTMF code is a standard way used to call other radios from one radio in the wireless communication. Therefore, most communication radios are equipped with this function. Also, the prior art systems do not indicate operator current equipment state.

U.S. Pat. No. 4,981,363 and U.S. Patent Applications 20120119900A1 provide examples of an electrical control circuit with remote radio signal transmitter, but it does not use DTMF signal and does not have repeaters system.

U.S. Patent Applications 20140347179A1 illustrate a wireless remote-control access and demodulates data on RF signal, but they do not use DTMF and repeaters system, and it only applies to light flashing pattern without a siren and other equipment.

U.S. Pat. No. 5,898,392 A shows a control circuit coupled to the vehicle bus interface and to the DTMF decoder for controlling through cellphone service; but does not have handheld or mobile radios as a remote control, does not send signal through radio repeaters system, and they are not for emergency vehicle application. This method uses telephone network and cellular network. This method and other similar systems are limited to the coverage of local cellular network carriers.

U.S. Pat. No. 7,825,790 B2 teaches a control system for an emergency vehicle light bar that can receive signals from a wireless remote control. The signal is transmitted via zigbee and the range is described as short. It does not disclose a repeater feature.

U.S. Pat. No. 8,963,705 B2 teaches a wireless interface module to control the light bar and siren using a WIFI signal for remote control. The disadvantage of WIFI signal is a short distance, and the user's cell phone cannot use the Internet while connected. It does not disclose a repeater feature.

Some current methods use the Wi-Fi function on the operators' smartphones, which limited the Internet access of operators' smartphones, and only have very limited control distance.

There remains a need for improved remote control of equipment in emergency vehicles, using phone band radios, with the ability to go through signal repeaters, at longer control distance.

### SUMMARY

In the new system, an additional wireless remote control is not required, and no additional charging station is needed to mount inside of the vehicle. Instead, the new system uses operator's communication radio through DTMF as a wireless remote. Also, the new system can go through repeaters to increase distance without being limited by the power of wireless remote control.

In one aspect of the invention, systems and methods are described herein for controlling a siren, warning light systems, auxiliary lighting and/or accessories such as winches or spot lights in a motorized vehicle from a county wide distance.

In a further aspect of the invention, the system uses handheld radios or mobile radios on other emergency vehicles as remote control devices, so no addition control devices needed to be carried by operator other than the radios they are using.

In another aspect of the invention, beside directly transmitting control signal from radio to vehicle, the new system can transmit and receive signal through repeater system to significantly increase operating distance.

In a further aspect of the invention, the DIME signal is analog signal which is able to go through analog repeater(s) system, which is usually used for communication by emergency agencies. Therefore, the control system will have the same control range as local repeater system. DTMF keyboard function is universally equipped on handheld and mobile professional radios, like WIFI on smartphones. Radios that do not have a DTMF keyboard function can still operate the system with a designed mobile device APP (application) along with the radio.

In further aspect of the invention, it is also possible to use digital signals and digital repeater in this new system instead of DTMF, when the agency operates their dispatch and communication on a digital-based radio system.

Additionally, this system is also able to notify the operator about the current state of the equipment.

The product disclosed in this application especially aims at emergency service which uses handheld or mobile two-way radio and emergency vehicle equipment such as lightbar and siren. By modifying the controller inside the vehicle, the operator can control at least some aspects of their light bars and/or sirens remotely, just using their existing radio system including repeaters.

The new system reduces the weight of equipment and the number of hardware components the operator needs to carry compared to the previously described systems by eliminating the need for an additional controller. The new system also reduces the cost of training for new equipment.

### BRIEF DESCRIPTION OF THE DRAWINGS

The above-mentioned and other features of this disclosure, and the manner of attaining them, will become more apparent and the disclosure itself will be better understood by reference to the following description of embodiments of the disclosure taken in conjunction with the accompanying drawings, wherein:

FIG. 1 illustrates an example system in which a handheld or mobile analog radio controls a light bar, siren, and other equipment via a wireless communication circuit in the example of DTMF signal.

FIG. 2 illustrates an example system in which a handheld or mobile analog radio controls a light bar, siren, and other equipment via a wireless analog repeater system in the example of DTMF signal.

FIG. 3 illustrates an application on a mobile device generating DTMF signal and connect to the radio by cables or voice through the air.

FIG. 4 illustrates an example system in which a handheld or mobile radio controls a light bar, siren, and other equipment via a digital repeater system in the example of digital radio signal.

Corresponding reference characters indicate corresponding parts throughout the several views. Although the drawings represent embodiments of the present disclosure, the drawings are not necessarily to scale and certain features may be exaggerated in order to better illustrate and explain the present disclosure.

### DETAILED DESCRIPTION OF THE EXEMPLARY EMBODIMENTS

The embodiments disclosed below are not intended to be exhaustive or limit the disclosure to the precise forms disclosed in the following detailed description. Rather, the embodiments are chosen and described so that others skilled in the art may utilize their teachings.

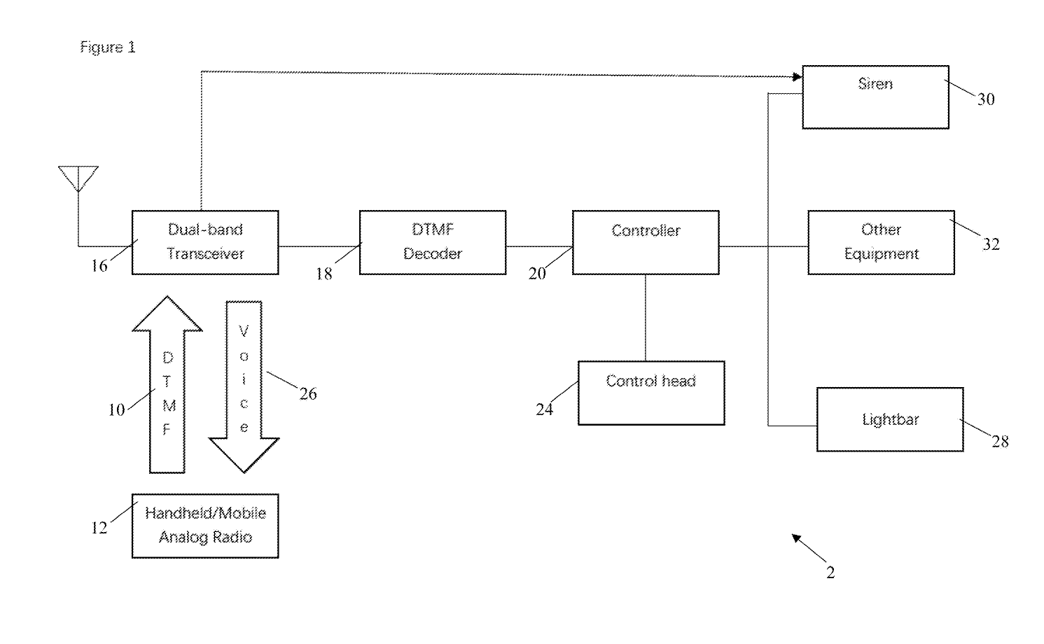

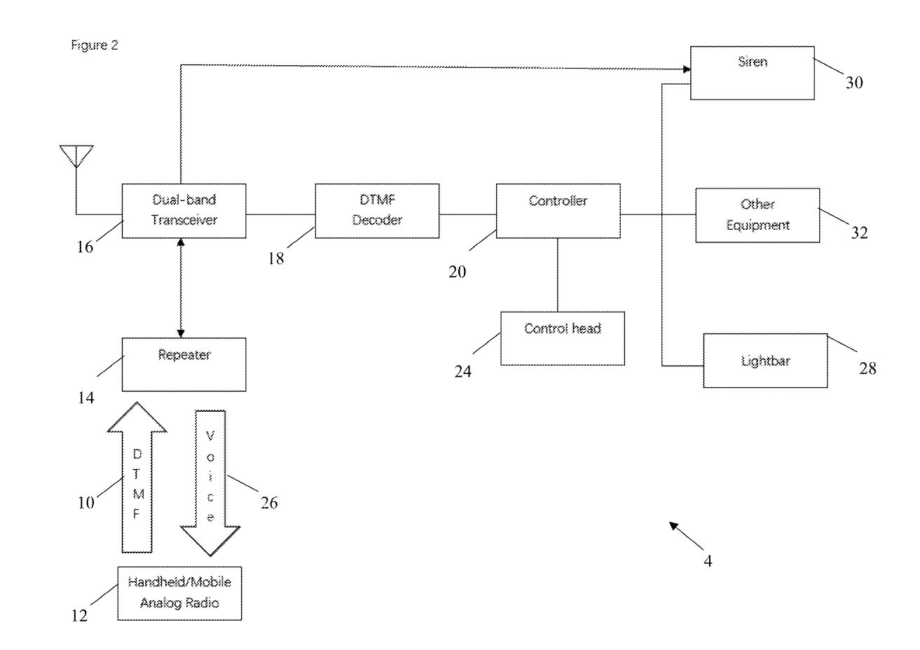

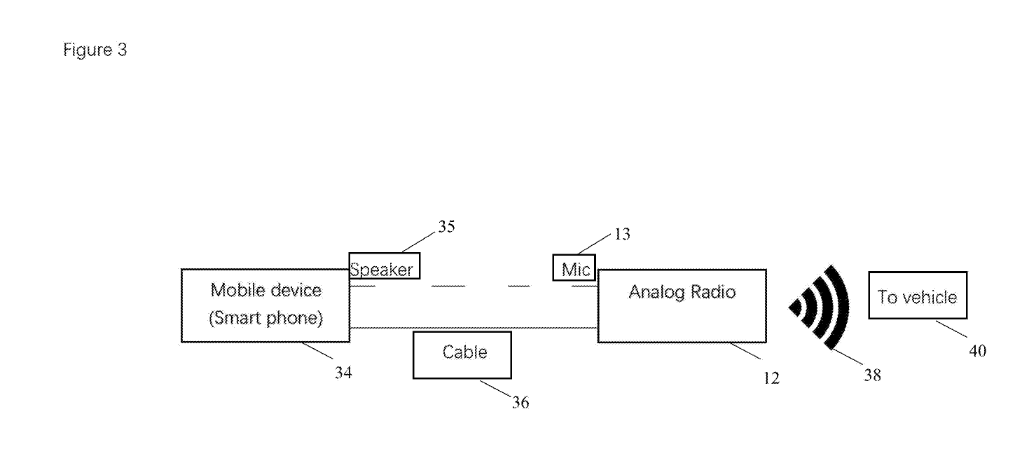

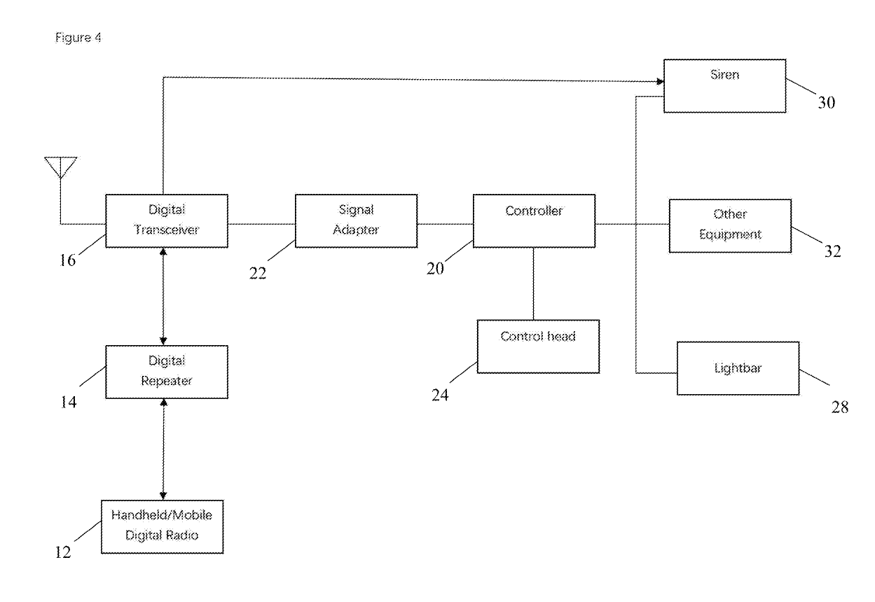

As illustrated in FIG. 1, DTMF signal 10 is generated by handheld or mobile radios 12 and transmitted to repeater(s) system 14 (FIGS. 2 and 4). Then, the repeater(s) system 14 transmit this DTMF signal 10 to vehicle 40 (FIG. 3). After the transceiver 16 on the vehicle 40 received the DTMF signal 10, the DTMF Decoder 18 decodes DTMF signal 10 and sends command to the controller 20 to trigger the function. After the function has been successfully triggered, transceiver 16 send voice 26 through repeater 14 indicating that the function has been successfully triggered to operators.

FIG. 1 illustrates the example of DTMF signal 10 without repeater 14 (FIGS. 2 and 4) in which a handheld or mobile analog radio 12 controls a light bar 28, siren 30, and other equipment 32 via a wireless communication circuit. DTMF signal 10 is generated by handheld or mobile analog radios 12 and transmitted directly to the dual-band transceiver 16 mounted on the vehicle 40.

The dual-band transceiver 16 is connected to DTMF decoding device 18, which decodes DTMF signal 10 into a control signal, which is readable by the controller 20. Then, the controller 20 sends command to a light bar 28, siren 30, and other equipment 32 (including speed radar, display screen, pan, tilt and zoom camera “PTZ camera”). Control signals may include any signal which affects function, such as ON or OFF commands, pattern selection commands, timing signals, or custom control signals. The controller 20 is also being able to receive control command from a control head 24, which mounts inside the vehicle 40. The dual-band transceiver 16 is also directly connected to the siren 30 or PA system to broadcast voice 26 received from handheld or mobile radio 12, at the same time using DTMF control.

The controller 20 is able to determine the current state of each vehicle 40 device and send the voice signal 26 to the dual-band transceiver 16. The vehicle 40 devices such as a light bar 28, siren 30, and other equipment 32. The current state includes ON or OFF, the pattern selected, and measurement reading, as an example of the speed radar reading and location information. The dual-band transceiver 16 transmits the voice signals 26 directly to Radio. Operators are able to hear all the information through voice 26. In one example, after operator change any state of the light bar 28 to “Code 3” remotely, the system indicates the change back to the operator by saying “Light bar now Code 3” through radio voice 26. In another example, after operator send command to ask for the current state of all the equipment, the system indicates the current state of all equipment one by one in a pre-programmed order.

The dual-band transceiver 16 is in one form receive or transmit a signal in the different frequency band (e.g., HF, VHF, UHF) in order to receive a signal from the radio with a different frequency band, via an antenna connected to the transceiver 16 via a cable. The handheld or mobile radio 12 can be either single band or dual band. The handheld or mobile radio 12 transmit DTMF signal 10 in analog mode or other digital signals (e.g. MDC1200) in the analog model to dual band transceiver 16. The dual-band transceiver 16 can be equipped with CTCSS to eliminate interference. The dual-band transceiver 16 is mounted on a vehicle 40 which also has mounted to it the light bar 28, siren 30, and other equipment 32. The antenna and transceiver 16 can be mounted in different locations on the vehicle 40. In one example, the transceiver 16 may be mounted on the rear deck of an emergency passenger vehicle 40, such as a police car, while the antenna is located on the roof or trunk. In another example, the transceiver 16 may be mounted within the light bar 28 control head 24 with antenna mount on top of the light bar 28.

In one form, FIG. 1 illustrates a system 2 for use on a vehicle 40 (FIG. 3) with a power supply (not shown). The light bar 28 is powered by the power supply and has a plurality of light heads (not shown) for providing emergency warning signals. The handheld or mobile radio 12 can be any radio with DTMF keyboard (e.g. Motorola HT series, XTS series, APX series) or radio without DTMF keyboard and a smartphone app, which generate DTMF signal 10 (See FIG. 3 for details).

The controller 20 is programmable via a computer programming software. The operator can program different DTMF signals 10 for different commands. The DTMF signal 10 can have only one digit or multiple digits. In one example, the operator can program DTMF signal 10 “1” to turn on all the lights, DTMF signal 10 “01” to turn on all lights facing rear, and “0” to ask for the current state for all the equipment.

As illustrated in FIG. 2, an example system 4 utilizing DTMF signal 10 in which a handheld or mobile analog radio 12 controls a light bar 28, siren 30, and other equipment 32 via a wireless analog repeater system 14. The DTMF signal 10 transmits to a transceiver 16 on the vehicle 40 through a repeater system 14 and is then decoded 18 by the controller 20 to control the light bar 28, siren 30, and other equipment 32.

FIG. 2 with analog repeater 14 illustrates an example system 4 in which a handheld or mobile analog radio 12 controls a light bar 28, siren 30, and other equipment 32 via a wireless analog repeater system 14 in the example of DTMF signal 10. DTMF signal 10 is generated by handheld or mobile analog radios 12 and transmitted through analog repeater(s) 14 to the transceiver 16 mounted on the vehicle 40.

The dual-band transceiver 16 is connected to DTMF decoding device 18, which decodes DTMF signal 10 into a control signal, which is readable by the controller 20. Then, the controller 20 sends command to a light bar 28, siren 30, and other equipment 32 (including speed radar, display screen, PTZ camera). Control signals may include any signal which affects function, such as ON or OFF commands, pattern selection commands, timing signals, or custom control signals. The controller 20 is also able to receive control command form a control head 24, which mounts inside the vehicle 40. The dual-band transceiver 16 is also connected to the siren 30 or PA system to broadcast voice 26 received from handheld or mobile radio 12, at the same time using DTMF control.

The handheld or mobile radio 12 transmits a DTMF signal 10 to the analog repeater system 14. When the repeater system 14 receives the DTMF signal 10, it transmits the same signal to the dual-band transceiver 16 mounted on the vehicle 40. The analog repeater system 14 can be only one repeater 14 or multiple repeaters or trunking analog repeater system. The dual-band transceiver 16 can operator different frequency band at the same time in order to receive signal from crossband repeater 14 or radio with different frequency band.

After the controller 20 determines the current state of each vehicle 40 devices and sends the voice signal 26 to the dual-band transceiver 16. The dual-band transceiver 16 transmits the voice signals 26 to the analog repeater 14. When the analog repeater system 14 receives the voice signal 26, it transmits the same voice signal 26 to the handheld or mobile radio 12 at operator side. Operators are able to hear all the information through voice 26.

As illustrated in FIG. 3, an application on a mobile device 34 generates DTMF signal 10 and connects to the radio 12 by cables 36 or voice 26 through the air. The application may also be used to connect a mobile device 34 to a handheld or mobile analog radio 12 to permit an operator to control the system using radio 12 without DTMF keyboard function.

FIG. 3 Illustrates an application (APP) on mobile device 34, which may include a portable computer, such as a smartphone or iPad. The user interface of the APP may comprise a mobile APP application executable by a cell phone or portable computer for generating DTMF signal 10. The device 34 is connected to the radio 12 by cables or voice 26 through the air.

The screen of user interface displaces different function icon. After the operator selects one icon, the APP generates the corresponding DTMF code through the audio output 35 (including speaker 35 and AUX port).

In one example operator can put the speaker 35 of smartphone 34 close to the microphone 13 of the radio 12, which does not have a built-in DTMF keyboard, and triggers the radio 12 to transmit while the app is generation DTMF signal 10 through the speaker 38. In another example, a cable 36 connected the audio output 35 of smartphone 34 and audio input 13 (and push to talk (PTT) signal) of the handheld or mobile radio 12, the app generates DTMF code while triggering the radio 12 to transmit through PTT signal.

As illustrated in FIG. 4, an example system utilizing digital radio signal in which a handheld or mobile radio 12 controls a light bar 28, siren 30, and other equipment 32 via a digital repeater system 14. The digital signal transmits to digital transceiver 16 on vehicle 40 through digital repeater system 14 and connects to controller 20 to control the light bar 28, siren 30, and other equipment 32.

FIG. 4 with digital repeater system 14 illustrates an example system in which a handheld or mobile radio 12 controls a light bar 28, siren 30, and other equipment 32 via a digital repeater system 14 in the example of digital radio signal (including DMR, dPMR, Astro, p25, TETRA, PDT, C4FM or CDMA, D-star). Digital control signal is generated by handheld or mobile radios 12 and transmitted through analog repeater(s) 14 to the transceiver 16 mount on the vehicle 40.

The digital transceiver 16 is connected to the controller 20 directly or through a signal adapter 22. Then, the controller 20 send command to a light bar 28, siren 30, and other equipment 32 (including speed radar, display screen, PTZ camera). Control signals may include any signal which affects function, such as ON or OFF commands, pattern selection commands, timing signals, display screen reprogramming, or custom control signals. The controller 20 is also able to receive control command form a control head 24, which is mounted inside the vehicle 40. The dual-band transceiver 16 is also connected to the siren 30 or PA system to broadcast voice 26 received from handheld or mobile radio 12.

A digital repeat system may also be used in this system, to increase operating distance.

The control able to determine the state of each connected equipment and send indication to operator through transceiver 16 via voice 26 or digital message and display.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed is:

1. A system to remotely control via wireless the light bars, sirens, and other equipment in an emergency vehicle, the system comprising:
a dual-band transceiver operatively coupled to a dual tone multi-frequency decoder or a digital signal adapter operatively coupled to a controller of the light bars, sirens, or other equipment in an emergency vehicle, and
a handheld or mobile analog radio having with DTMF keyboard or digital signal processing, an analog radio system communicatively coupled to a smartphone app, or a digital radio.

2. The system of claim 1 wherein handheld or mobile radio is a handheld radio or mobile radio on another emergency vehicle or a stationary mobile radio.

3. The system of claim 1 further comprising an analog or digital repeater system.

4. The system of claim 3 wherein the analog repeater system is selected from the group consisting of one repeater, multiple repeaters and a trunking repeater system.

5. The system of claim 4 wherein the repeater is selected from the group consisting of DMR, dPMR, Astro, P25, TETRA, PDT, C4FM or CDMA, and D-star.

6. The device of claim 1, wherein the system has a range of at least 150 meters.

7. The device of claim 1 wherein other equipment includes speed radar, display screen, or PTZ camera.

8. The device of claim 1 wherein the system utilizes control signals including any signal which affects function, including ON or OFF commands, pattern selection commands, timing signals, or custom control signals.

9. The device of claim 1 wherein the controller is also able to receive control command from a control head inside the vehicle.

10. The device of claim 1 wherein the dual-band transceiver is also directly connected to a siren or public address system to broadcast voice received from handheld or mobile radio at the same time using DTMF control.

11. The device of claim 1 wherein smartphone app includes mobile application executable by a cell phone or portable computer for generating DTMF signal.

12. A method of controlling emergency equipment on a vehicle, the method comprising the steps of
generating DTMF signal by a either a handheld or mobile radio having with DTMF keyboard and digital signal processing or a digital or analog radio system communicatively coupled to a smartphone app,
transmitting the DTMF signal to a repeater system,
transmitting the DTMF signal to a transceiver on the vehicle, wherein the vehicle includes a DTMF decoder and a controller,
triggering function of the emergency equipment and
sending voice through the repeater indicating that the function has been successfully triggered.

13. The method of claim 10, further comprising the step of decoding the DTMF signal into a control signal, reading the control signal by the controller, commanding the emergency equipment including a light bar, siren, speed radar, display screen, or PTZ camera, to perform a function,

14. The method of claim 10, wherein the control signals include any signal which affects function selected from the group consisting of ON or OFF commands, pattern selection commands, timing signals, and custom control signals.

15. The method of claim 10, wherein generating DTMF signal by the digital or analog radio system communicatively coupled to the smartphone app, wherein the radio system is without DTMF keyboard function, wherein the smartphone app connects to the radio by either cables or voice, wherein the smartphone app is on a mobile device selected from the group consisting of a portable computer, a smartphone and an iPad.
